(19) United States
(12) Patent Application Publication
(10) Pub. No.: US 2016/0156826 A1
(43) Pub. Date: Jun. 2, 2016

(54) IMAGE-CAPTURING DEVICE AND IMAGE-CAPTURING METHOD

(71) Applicant: SOCIONEXT INC., Yokohama-shi (JP)

(72) Inventors: Soichi Hagiwara, Komae (JP); Naoki Sakamoto, Yokohama (JP)

(21) Appl. No.: 14/877,633

(22) Filed: Oct. 7, 2015

(30) Foreign Application Priority Data
Nov. 27, 2014 (JP) 2014-240406

(51) Int. Cl. H04N 5/235; H04N 3/14; H04N 5/355; G06T 3/40; G06T 7/20

(52) U.S. Cl. CPC H04N 5/2353; G06T 3/4007; G06T 7/2073; H04N 5/35536; H04N 3/155

(57) ABSTRACT

An image-capturing device includes an image sensor, and an image processing device. The image sensor includes a central portion configured to perform image-capturing with a first frame rate, and a peripheral portion provided around the central portion configured to perform image-capturing with a second frame rate higher than the first frame rate. The image processing device is configured to calculate an image-capturing condition in the central portion on the basis of image data captured by the peripheral portion.

### CROSS-REFERENCE TO RELATED APPLICATION

This application is based upon and claims the benefit of priority of the prior Japanese Patent Application No. 2014-240406, filed on Nov. 27, 2014, the entire contents of which are incorporated herein by reference.

### FIELD

The embodiments discussed herein are related to an image-capturing device and an image-capturing method.

### BACKGROUND

In recent years, various devices are now equipped with an image-capturing function (camera). By the way, in the object detection and analysis technique using the camera, it is considered to be important to instantaneously detect and analyze an object.

For example, a technique for dividing an image sensor into a central portion where the pixel density is high and a peripheral portion where the pixel density is low, operating the peripheral portion having less processing data at a high frame rate, and detecting an entry of an object into the field of vision at an earlier point in time has been suggested as a conventional technique for such purpose.

A technique for arranging small and high resolution pixels in the central portion of a sensor and arranging large and low resolution pixels in the peripheral portion thereof to improve the frame rate of the sensor has also been suggested.

In the image sensor in which the small and high resolution pixels are arranged in the central portion and large and low resolution pixels are arranged in the peripheral portion, for example, it is considered to operate the peripheral portion having less processing data at a high frame rate.

At this occasion, in the peripheral portion, the pixel size is large, and therefore, an exposure time required for a single image-capturing can be short, but it is difficult to find the details of the object. In the central portion, the pixel size is small, and therefore, the exposure time becomes longer, and it is difficult to find the details of the object unless an image-capturing conditions (for example, image-capturing start timing, exposure time, ISO sensitivity, and the like) are accurately adjusted.

More specifically, in the central portion, for example, when the exposure time is too long for the speed of the subject (object), the image becomes blurry, and when the image-capturing start timing is too early or too late, image-capturing is performed while the subject is out of the field of vision, which makes it difficult to appropriately capture the image of the subject.

By the way, in the past, various suggestions have been presented to capture images by changing the pixel density and the resolution in the central portion and the peripheral portion of the image sensor.

Patent Document 1: Japanese Laid-open Patent Publication No. 2010-183281

Patent Document 2: U.S. Pat. No. 4,554,585

Patent Document 3: U.S. Pat. No. 6,455,831

Patent Document 4: U.S. Pat. No. 8,169,495

Patent Document 5: U.S. Pat. No. 4,267,573

Patent Document 6: Japanese Laid-open Patent Publication No. 2002-026304

Patent Document 7: U.S. Pat. No. 5,887,078

Non-Patent Document 1: Satoru ODA, “Pointing Device Using Higher-Order Local Autocorrelation Feature in Log Polar Coordinates System,” The Bulletin of Multimedia Education and Research Center, University of Okinawa no. 4, pp. 57-70, March 2004

### SUMMARY

According to an aspect of the embodiments, there is provided an image-capturing device includes an image sensor, and an image processing device.

The image sensor includes a central portion configured to perform image-capturing with a first frame rate, and a peripheral portion provided around the central portion configured to perform image-capturing with a second frame rate higher than the first frame rate. The image processing device is configured to calculate an image-capturing condition in the central portion on the basis of image data captured by the peripheral portion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing for explaining an example of an image sensor that is applied to an image-capturing device according to the present embodiment;

FIG. 2 is a drawing schematically explaining an image-capturing method according to the present embodiment;

FIG. 3 is a drawing for explaining an example of image-capturing processing performed by the image-capturing device according to the present embodiment;

FIG. 4 is a drawing for making explanation by comparing processing in a case where an image sensor applied to the present embodiment is a polar coordinate system sensor and in a case where the image sensor applied to the present embodiment is a rectangular coordinate system sensor;

FIG. 5 is a drawing for explaining an example of calculation operation of an image-capturing condition in the image-capturing device according to the present embodiment (part 1);

FIG. 6 is a drawing for explaining an example of calculation operation of an image-capturing condition in the image-capturing device according to the present embodiment (part 2);

FIG. 7 is a drawing for explaining an example of calculation operation of an image-capturing condition in the image-capturing device according to the present embodiment (part 3);

FIG. 8 is a drawing illustrating an image-capturing device according to a first embodiment;

FIG. 9 is a drawing illustrating an image-capturing device according to a second embodiment;

FIG. 10 is a flowchart for explaining an example of image-capturing processing in an image-capturing device according to the present embodiment;

FIG. 11 is a flowchart for explaining an example of calculation processing of an image-capturing condition in the image-capturing device according to the present embodiment;

FIG. 12 is a drawing for explaining another example of an image sensor applied to the image-capturing device according to the present embodiment;

FIG. 13 is a drawing illustrating an image-capturing device according to a third embodiment; and

FIG. 14 is a drawing illustrating an image-capturing device according to a fourth embodiment.

### DESCRIPTION OF EMBODIMENTS

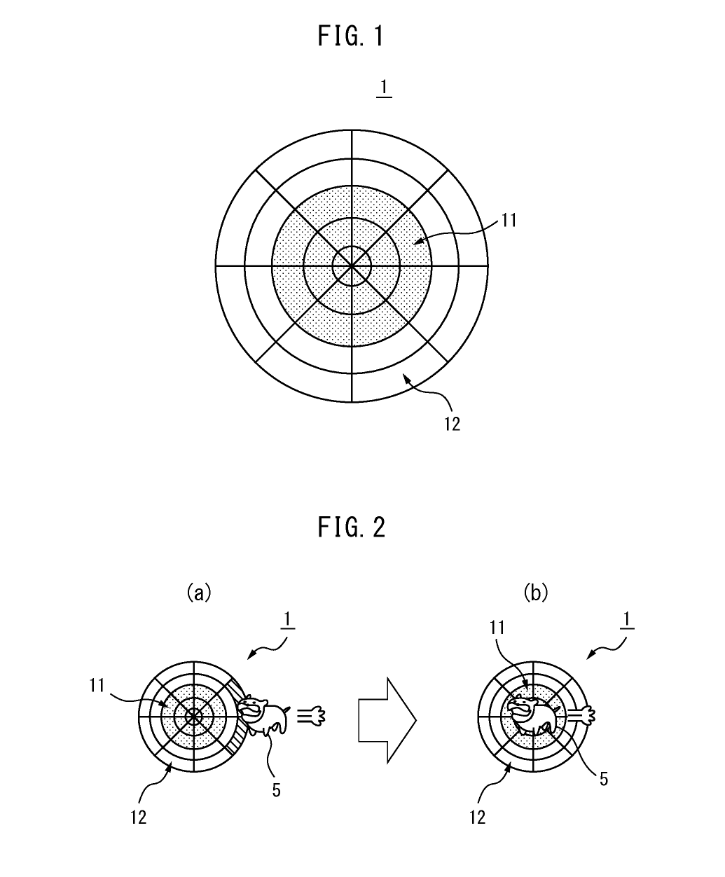

Hereinafter, an embodiment of an image-capturing device and an image-capturing method will be explained in details with reference to appended drawings. FIG. 1 is a drawing for explaining an example of an image sensor applied to an image-capturing device according to the present embodiment, and illustrates a polar coordinate system sensor 1.

As shown in FIG. 1, an polar coordinate system sensor 1 applied to the present embodiment includes, for example, a central portion 11 of which pixel size is small and in which the pixel density is high and a peripheral portion 12 of which pixel size is large and in which the pixel density is low.

In this case, although explained later in details, the central portion 11 captures (shoots) images with a low frame rate (for example, 60 frames/second (fps)), and the peripheral portion 12 captures images with a high frame rate (for example, 1000 fps).

It should be noted that the image sensor applied to the present embodiment is not limited to the polar coordinate system sensor 1, and as explained later in details, the image sensor applied to the present embodiment can also be applied to a generally-available rectangular coordinate system sensor in the same manner. Further, even with a pixel shape other than the polar coordinate system and the rectangular coordinate system sensor, the image sensor applied to the present embodiment can be applied to various other image sensors by, for example, generating an intermediate pixel by using a pixel interpolation technique (bilinear and the like) and making equivalent pixel arrangement.

It should be noted that, for example, an image-capturing device according to the present embodiment may capture an image of a motion picture, or may capture an image of a still picture. Further, the motion picture and still picture which have been captured may be provided to the user as they are, but, for example, the motion picture and still picture may be give as various kinds of image data such as an image processing system performing detection and analysis of the object.

In the polar coordinate system sensor (image sensor) 1 as shown in FIG. 1, the pixel size becomes smaller toward the center and the pixel size becomes larger toward the periphery in a concentric circle manner, but, for example, all the pixels of the sensor 1 may be of the same size.

In this case, for example, the central portion 11 processes the pixels as they are, and the peripheral portion 12 processes multiple pixels (for example, 4, 8, 16 pixels and the like) treated collectively as a single pixel.

In this specification, for the sake of simplifying the explanation, a single polar coordinate system sensor 1 is divided into two areas, i.e., the central portion 11 and the peripheral portion 12, but, for example, a single polar coordinate system sensor 1 may be divided into three or more areas such as providing an intermediate portion between the central portion 11 and the peripheral portion 12.

At this occasion, the pixel size of the intermediate portion is configured to be, for example, a size between the pixel size of the central portion 11 and the pixel size of the peripheral portion 12, and the frame rate of the intermediate portion is configured to be a speed between the frame rate of the central portion 11 and the frame rate of the peripheral portion 12.

FIG. 2 is a drawing schematically explaining an image-capturing method according to the present embodiment, and is to explain an example where a dog (object) 5 moves in a direction from the right to the left on the field of vision of the image sensor 1. More specifically, FIG. 2(a) illustrates the object 5 entering into the field of vision of the peripheral portion 12 of the image sensor 1, and FIG. 2(b) illustrates the object 5 entering into the field of vision of the central portion 11 of the image sensor 1 after a time passes since the state of FIG. 2(a).

As described above, the image sensor 1 is configured such that, in the central portion 11, for example, the pixel size is small and the pixel density is high, and in the peripheral portion 12, the pixel size is large and the pixel density is low. Further, in the central portion 11, the object 5 is captured with a low frame rate (for example, 60 fps), and in the peripheral portion 12, the object 5 is captured with a high frame rate (for example, 1000 fps).

First, as shown in FIG. 2(a), when the object 5 enters into the field of vision of the peripheral portion 12 of the image sensor 1, the optimum image-capturing condition in a case where the object enters into the field of vision of the central portion 11 of the image sensor 1 is derived from the data captured in the peripheral portion 12.

Then, as shown in FIG. 2(b), when the object 5 enters into the field of vision of the central portion 11 of the image sensor 1, the image of the object 5 is captured on the basis of the optimum image-capturing condition derived from the image-captured data in the peripheral portion 12.

In this case, the reason why the image-capturing can be done in the peripheral portion 12 with the high frame rate is that the size of the pixel in the peripheral portion 12 is large, and therefore, the exposure time required for a single image-capturing can be short, and further the pixel density is low, so that the number of pixels to be processed can be reduced.

The data from the peripheral portion 12 have a low pixel density, and therefore, the resolution of the obtained image becomes lower, but is sufficient for calculating the image-capturing conditions (image-capturing start timing, exposure time, ISO sensitivity, and the like) of the central portion 11 explained above.

As described above, the peripheral portion 12 of the high frame rate finds, for example, a high-speed object such as a moving animal and a flying bullet, and the optimum image-capturing condition for performing the image-capturing in the central portion 11 is calculated, and the central portion 11 performs appropriately image-capturing to capture the object on the basis of the optimum image-capturing condition. It is to be understood that the central portion 11 where the image-capturing is performed with a low frame rate may capture still pictures.

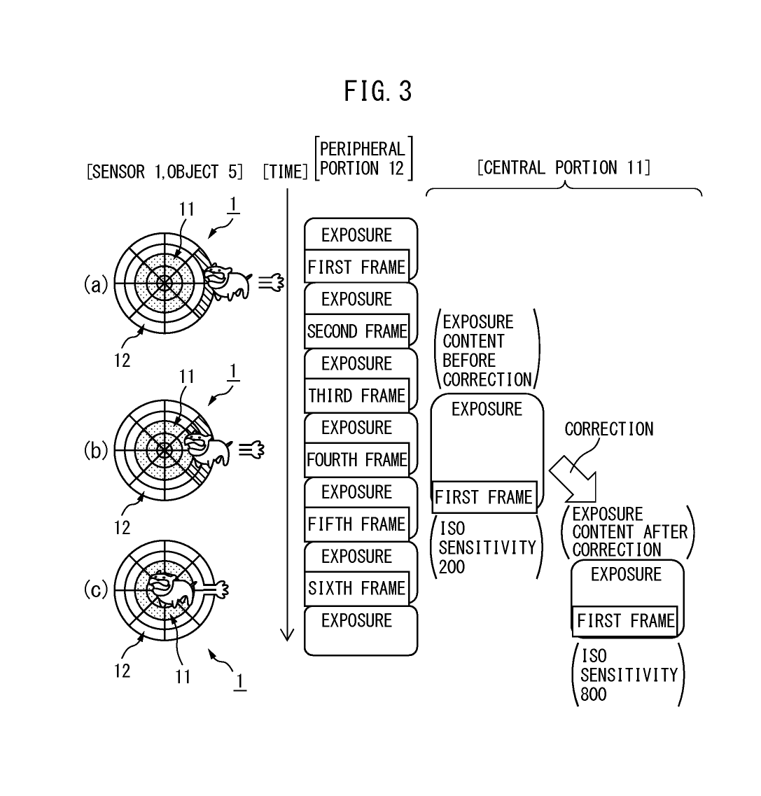

FIG. 3 is a drawing for explaining an example of image-capturing processing in the image-capturing device according to the present embodiment. In FIG. 3, the time elapses from the upper side to the lower side, and the relationship of the image sensor land object (object on the image sensor) 5 changes from FIG. 3(a) to FIG. 3(b) and then to FIG. 3(c) as the time passes.

In this case, FIG. 3(a) illustrates a moving object (dog) 5 entering into the field of vision of the peripheral portion 12 of the image sensor 1, and FIG. 3(b) illustrates the object 5 moving from the field of vision of the peripheral portion 12 to the field of vision of the central portion 11, and FIG. 3(c) illustrates the object 5 moving in the central portion 11.

FIG. 3(a) and FIG. 3(b), for example, a change in the peripheral portion 12 of the image sensor 1 is monitored while image-capturing is performed with 1000 fps, and in the peripheral portion 12, the object 5 is captured in a first frame, a second frame, . . . on the basis of the image-capturing conditions (exposures) defined in advance. Then, for example, timing and the like when the object 5 enters into the central portion 11 of the sensor 1 is calculated from the difference between the first frame and the second frame.

More specifically, in the peripheral portion 12, the pixel size is large, and therefore, it is difficult to perform analysis to find what had entered, but the exposure time and the frame rate is high, and therefore, the entry of the object 5 can be detected instantaneously, and the movement information such as the position, the speed, and the direction of the object 5 can be derived.

Then, the image-capturing conditions (image-capturing timing, exposure time, ISO sensitivity, and the like) with which the object 5 can be captured in an optimum manner in the central portion 11 is calculated on the basis of the movement information about the object 5 derived from the image-captured data of the high frame rate from the peripheral portion 12.

It should be noted that the processing for calculating the movement information from the image-captured data of the peripheral portion 12 and calculating the image-capturing conditions for the central portion 11 from the movement information is performed by, for example, the image processing/image analysis device (image processing device) 200.

Then, as shown in FIG. 3(c), when the object 5 moves in the field of vision of the central portion 11, the image-capturing conditions defined in advance (initial conditions: for example, the ISO sensitivity 200) are corrected to the optimum image-capturing conditions (for example, ISO sensitivity 800) derived from the data captured in the peripheral portion 1.

Therefore, the central portion 11 of the image sensor 1 can capture the object 5 with the optimum image-capturing condition (image-capturing timing, exposure time, ISO sensitivity, and the like). In this case, for example, even if the central portion 11 has a low frame rate such as 60 fps, the pixel size is small and the pixel density is high in the central portion 11, and therefore, the object 5 can be captured appropriately by capturing the optimum image-capturing conditions.

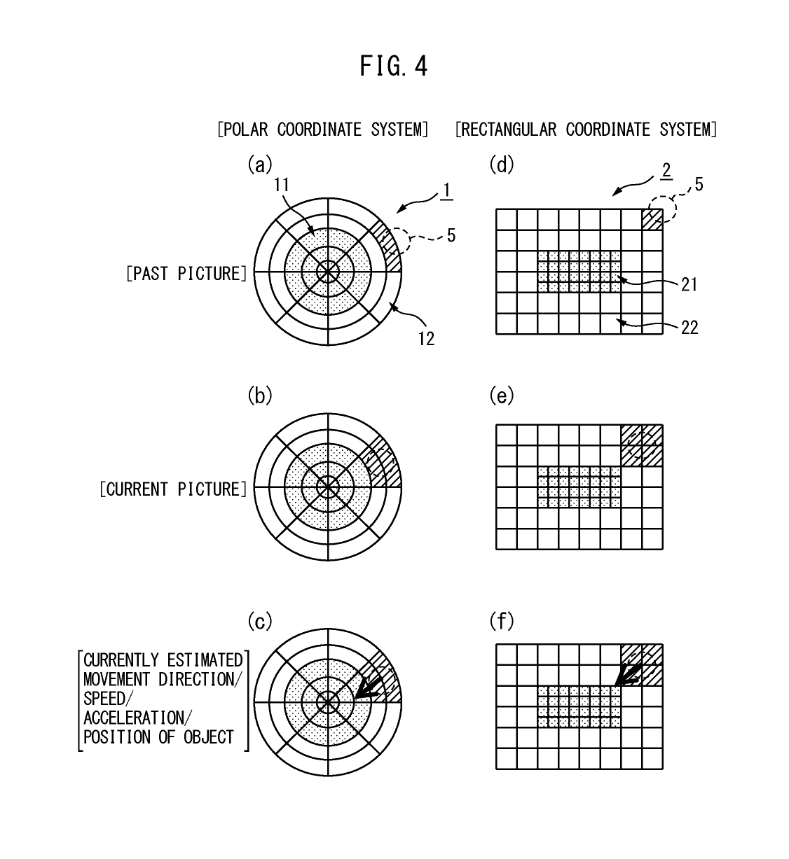

A known technique can be applied, as it is, to the detection of the position, the speed, the acceleration, and the movement direction (movement information: the position, the speed, the movement direction, and the like) of the entering object 5. FIG. 4 is a drawing for making explanation by comparing processing in a case where an image sensor applied to the present embodiment is a polar coordinate system sensor and in a case where the image sensor applied to the present embodiment is a rectangular coordinate system sensor, and illustrates two types of typical image sensors.

The present embodiment can also be applied to various other image sensors by, for example, making an equivalent pixel arrangement by generating an intermediate pixel by using a pixel interpolation technique (bilinear and the like) even in a pixel shape other than the polar coordinate system and the rectangular coordinate system sensor, which is what has been described above.

FIG. 4(a) to FIG. 4(c) illustrate a polar coordinate system sensor (polar coordinate sensor) 1, and FIG. 4(d) to FIG. 4(f) illustrate a rectangular coordinate system sensor (rectangular sensor) 2. It should be noted that FIG. 4(a) and FIG. 4(d) illustrate a past picture (a part of the object 5 enters into the field of vision of the peripheral portion 12, 22), and FIG. 4(b) and FIG. 4(e) illustrate a current picture (the entire object 5 is included in the field of vision of the peripheral portion 12, 22). FIG. 4(c) and FIG. 4(f) illustrate the position, the speed, the acceleration, and the movement direction (movement information) of the object currently predicted.

First, in the case of the polar coordinate system sensor 1, for example, the position, the speed, the acceleration, and the movement direction (the movement information) of the current object 5 can be calculated as shown in FIG. 4(c) from multiple frame images capturing the object 5 moving as shown in FIG. 4(a) and FIG. 4(b). For example, the position and the motion of the object 5 can be estimated by motion estimation of the moving object 5 by using the time difference, the spatial difference, and the color information.

Depending on the implementation, the peripheral portion 12 may be a brightness sensor not using any color filter. In this case, without using any color information, the moving object 5 is calculated from the time and spatial difference.

Subsequently, as shown in FIG. 4(d) to FIG. 4(f), in a case of the rectangular coordinate system sensor 2, for example, the movement information of the current object 5 can be estimated by applying an existing technique such as an optical flow.

As described above, a known technique can be applied, as it is, to the detection of the position, the speed, the acceleration, the movement direction (movement information: the position, the speed, and the movement direction, and the like) of the entering object (object) 5 in the peripheral portion 12 of the polar coordinate system sensor 1 and the peripheral portion 22 of the rectangular coordinate system sensor 2.

Hereinafter, the acquisition of the exposure start possible timing range and the determination of the image-capturing conditions (image-capturing start timing, exposure time, ISO, and the like) in the central portion 21 on the basis of the movement information of the detected moving object will be explained using an example of the rectangular coordinate system sensor 2.

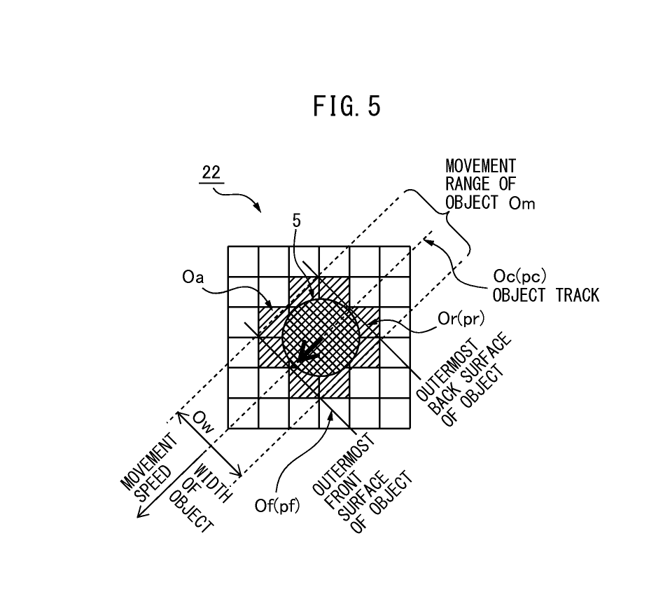

FIG. 5 to FIG. 7 are figures for explaining examples of calculation operation of the image-capturing conditions in the image-capturing device according to the present embodiment, and explain the calculation operation of the exposure start timing in a case where the image sensor is the rectangular coordinate system sensor 2.

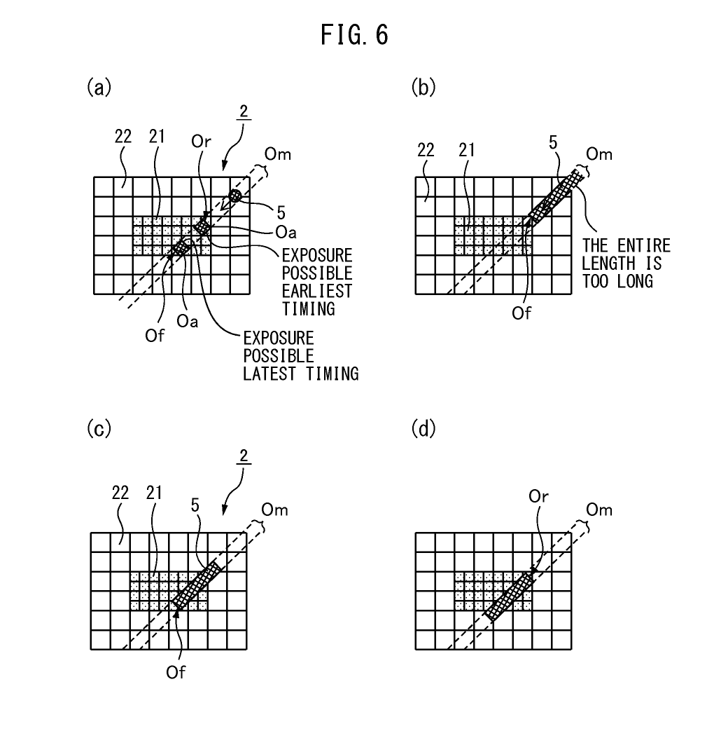

First, the acquisition of the exposure start possible timing range will be explained with reference to FIG. 5 and FIG. 6. As shown in FIG. 5, for example, the range and the like occupied by the object 5 is defined in the peripheral portion 22 of the image sensor 2.

More specifically, a line segment which is perpendicular to the movement direction of the object passing through the center of the exiting pixels of the object 5 and which is located at the outermost front in the movement direction is defined as a outermost front surface Of of the object, and a line segment located at the outermost back side in the movement direction is defined as a outermost back surface Or of the object.

Further, an area enclosed by most outer side line segments in parallel with the movement direction of the object passing through the existing pixel center of the object 5 is referred to as a movement range Oa of the object, and the size of the area is referred to as a width Ow of the object, and a straight line in parallel with the movement direction of the object and passing through the intermediate position of Oa is referred to as an object track Oc. An area enclosed by the outermost front surface Of of the object, the outermost back surface Or of the object, and the movement range Oa of the object is defined as the object area Oa (a hatching area in FIG. 5: including the area of the object 5).

It should be noted that the outermost front surface Of, the outermost back surface Or, the movement range Om, the width Ow, the object track Oc, and the object area Oa of the above object can be derived at a time when the movement information of the object 5 is calculated by applying, for example, an existing technique such as an optical flow as shown in, for example, FIG. 4(d) to FIG. 4(f).

Subsequently, the range of the timing in which the exposure start can be started is obtained. In this case, as shown in FIG. 6(a), a case of the most simple straight line motion (the vectors of the speed and the acceleration are parallel) will be explained. In a case of other than the straight line motion, for example, when the acceleration is assumed to be, e.g., constant, the exposure start possible timing range can be easily calculated on the basis of the position, the speed, and the acceleration of the object 5.

More specifically, where the distance from the distance from the position of the object 5 at the current point in time is denoted as x, the magnitude of the current speed of the object 5 is denoted as v, the magnitude of the current acceleration of the object 5 is denoted as a, and the time from the current point in time is denoted as t, x can be derived from the following equation (1).

x=vt+(½)*at2 (1)

In this case, the position where all the object area Oa is first included in the field of vision of the center area (the area of the central portion 21 of the image sensor 2) is the timing when the image-image capturing is possible at an earliest point in time (which may be hereinafter referred to as “the earliest timing”), and the position where all the object area Oa is included in the field of vision of the center area at the last point in time is the timing when the image capturing is possible at the last point in time (which may be hereinafter referred to as “the latest timing”).

Therefore, the exposure timing at each position can be obtained by substituting the distance to each position into the above equation (1). More specifically, the image-capturing start timing in the central portion 21 (center area) can be set between the earliest timing and the latest timing in which the image capturing can be performed. In this case, the determination of the image-capturing start timing may not be at this point in time, and, for example, the determination can also be determined by making adjustment with a determination processing of image-capturing conditions explained subsequently.

When a part of the object is out of the field of vision and the entire length is unknown, or when the entire length of the object 5 is too long and it does not fit within the field of vision of the center area, image-capturing is performed by dividing it into multiple images. In this case, FIG. 6(b) to FIG. 6(d) illustrate a case where the entire length of the object 5 is too long, and it does not fit within the field of vision of the central portion 21.

More specifically, as shown in FIG. 6(b), when the entire object 5 is determined not to be able to be captured in a single image-capturing of the central portion 21 from the movement information of the object 5 in the peripheral portion 22, first, as shown in FIG. 6(c), the image-capturing is performed immediately before the outermost front surface Of of the object goes out of the field of vision of the central portion 21.

Further, as shown in FIG. 6(d), the image-capturing is performed immediately after the outermost back surface Or of the object enters into the field of vision of the central portion 21. As described above, the image capturing is performed in the central portion 21 by paying attention to the timing when the outermost front surface Of goes out of the field of vision of the central portion 21 and the timing when the outermost back surface Or enters into the field of vision of the central portion 21, so that the size of area of the object 5 captured in a single image-capturing can be enlarged.

It is to be understood that the image-capturing of three or more images may be performed in order to find the entire object 5 depending on the relationship of the length of the object 5 (the length of the field of vision on the image sensor 2) and the size of the central portion 21 of the image sensor 2.

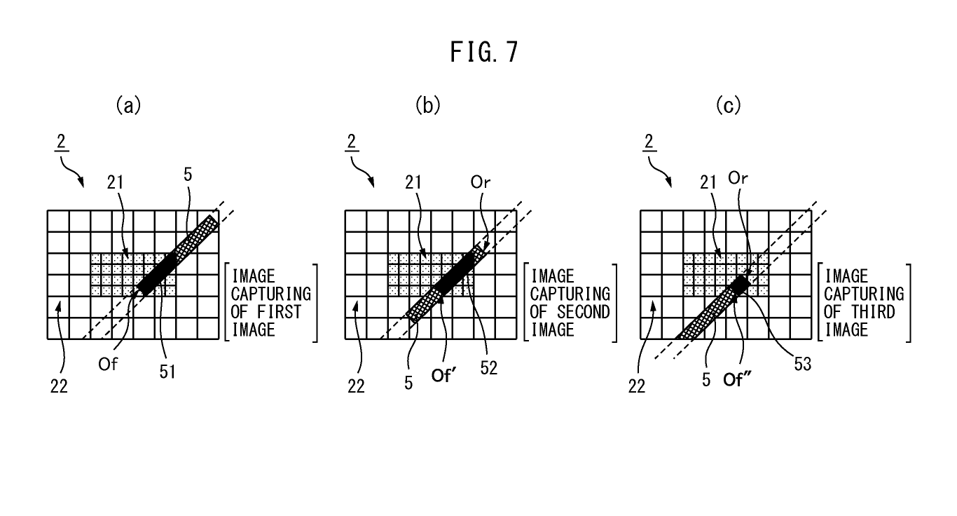

Lastly, the determination of the image-capturing conditions of the central portion 21 on the basis of the movement information of the detected moving object will be explained with reference to FIG. 7. In this case, FIG. 7(a) illustrates image-capturing of the first image in the central portion 21, FIG. 7(b) illustrates image-capturing of the second image in the central portion 21, and FIG. 7(c) illustrates image-capturing of the third image in the central portion 21.

By the way, in a case where the moving object 5 fits within the field of vision of the center area (central portion 21), the allowed range of the exposure time (setting possible exposure time) Tca is limited to a range in which image capturing of the object 5 can be performed with an appropriate brightness with the brightness of the subject and the ISO sensitivity.

Further, the setting possible exposure time Tca is limited to a range in which there is no motion blur in the captured object 5 due to the speed v of the moving object (object 5). In this case, the motion blur is determined by how many pixels the object 5 is moved in the exposure period, and therefore, it depends on the size of the pixel.

In view of the above, the setting possible exposure time Tca can be expressed by the following equation (2).

ρ=(Wmin*Amin)/(v*Lm*ISOa)≧Tca≧(Wmin*Amax)/(v*Lm*ISOa) (2)

In the above equation (2), ρ denotes a constant, Amin denotes a permitted possible minimum exposure amount, Amax dentoes a permitted possible maximum exposure amount, ISOa denotes an ISO sensitivity (the ISO sensitivity of the central portion 21), Wmin denotes a central portion minimum pixel short side length, Lm denotes a moving object average brightness, and v denotes a speed of the object 5 (moving object). It should be noted that the moving object average brightness Lm denotes a brightness received by the brightness sensor, and the moving object speed v changes by the image-capturing timing.

In this case, appropriate image-capturing of a subject can be performed by performing exposure and image-capturing with any exposure time within the range of Tca and ISOa that have been set from any timing in the exposure start possible timing range derived as explained with reference to FIG. 5 and FIG. 6.

Subsequently, a case where the moving object (object 5) is larger than the field of vision of the center area or the entire moving object is out of the field of vision will be explained. For example, when the object 5 is large, and a part of the object 5 is still out of the field of vision of the peripheral portion 22, it is difficult to capture the entire object 5 with a single image-capturing. In such case, control is performed to capture the entire image of the object 5 by image capturing (shooting) of multiple images.

More specifically, first, as shown in FIG. 7(a), the area 51 of the object 5 included in the central portion 21 is captured as the first image at the timing obtained by subtracting the exposure time from the exposure possible earliest timing (the timing when the outermost front surface Of of the object 5 goes out of the field of vision of the central portion 21).

Subsequently, as shown in FIG. 7(b), the outermost front surface Of′ of the area that could not captured in the image-capturing of the first image is set again to the outermost front surface (Of) of the object 5 of the image-capturing of the first image. Further, the area 52 of the object 5 included in the field of vision of the central portion 21 is captured as the second image at the timing obtained by subtracting the exposure time from the exposure possible earliest timing of the outermost front surface Of′.

Then, as shown in FIG. 7(c), the outermost front surface Of″ of the area that could not captured in the image-capturing of the second image is set again to the outermost front surface (Of) of the object 5 of the image-capturing of the first image. Further, the area 53 of the object 5 included in the field of vision of the central portion 21 is captured as the third image at the timing obtained by subtracting the exposure time from the exposure possible earliest timing of the outermost front surface Of′.

In the example of FIG. 7(a) to FIG. 7(c), the outermost back surface Or of the object 5 is included in the image captured as the third image, and therefore, the image-capturing is terminated in the third image, but when the outermost back surface Or of the object 5 is not included in the image captured as the third image, the same processing is repeated.

Therefore, even when the length of the object 5 is longer than the field of vision of the central portion 21, the entire object 5 can be captured by performing image-capturing of multiple images. What has been described above is merely an example, and it is to be understood that various other methods may also be applied. In addition, the image-capturing conditions for the central portion 21 are just predictions as explained above, and therefore, even if the image-capturing conditions are once determined, it is preferable to keep on updating at all times on the basis of subsequent image-captured data of the peripheral portion 22.

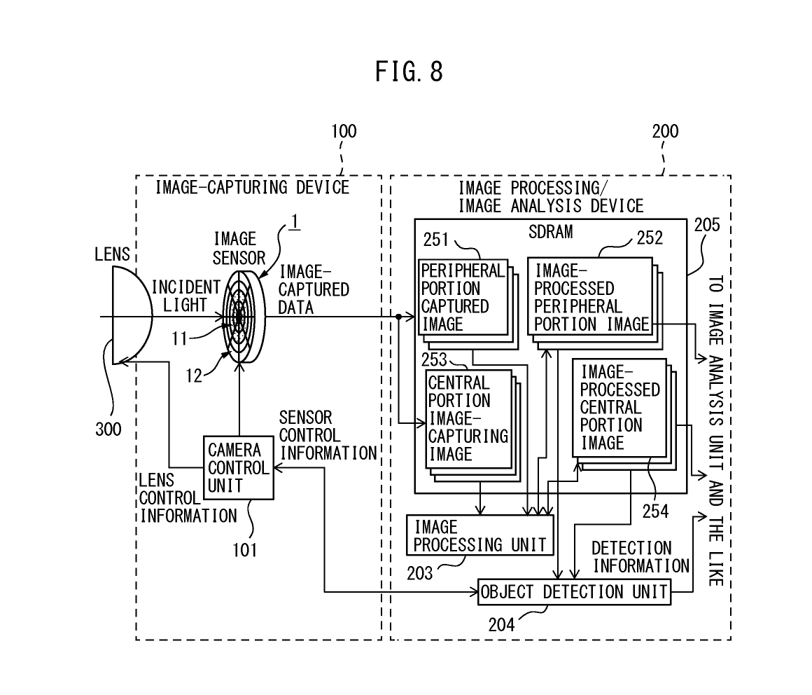

FIG. 8 is a drawing illustrating an image-capturing device according to the first embodiment, and, for example, illustrates an example of image-capturing device applied to an image processing system such as a monitor camera and a vehicle-mounted camera.

As shown in FIG. 8, the image-capturing device according to the first embodiment includes an image-capturing device 100, an image processing/image analysis device (image processing device) 200, and an optical system 300 such as a lens. In FIG. 8, the polar coordinate system sensor 1 is applied as an image sensor, but is not limited thereto.

The image-capturing device 100 includes a polar coordinate system sensor (image sensor) 1 and a camera control unit 101. As described above, the sensor 1 includes the central portion 11 and the peripheral portion 12, and configured to receive incident light from the optical system 300, convert the light into an electric signal, and output image-captured data to the image processing device 200.

The camera control unit 101 controls the sensor 1 on the basis of the sensor control information from the image processing device 200 (object detection unit 204), and controls the optical system 300 on the basis of the lens control information. The camera control unit 101 outputs various kinds of information about the sensor land optical system 300 to the object detection unit 204.

In this case, the camera control unit 101 performs control so as to perform the image-capturing with a low frame rate (for example, 60 fps) in the central portion 11 of the sensor 1, and performs control so as to perform the image-capturing with a high frame rate (for example, 1000 fps) in the peripheral portion 12 of the sensor 1.

The image processing device 200 includes an SDRAM (memory)205, an image processing unit 203, and an object detection unit 204. The SDRAM 205 receives the image-captured data from the sensor 1, and stores the image captured in the peripheral portion 12 as a peripheral portion image-capturing image 251, and stores the image captured in the central portion 11 as a central portion image-capturing image 253.

The image processing unit 203 receives and processes the peripheral portion image-capturing image 251 and the central portion image-capturing image 253 stored in the SDRAM 205, and stores the processed images as an image-processed peripheral portion image 252 and an image-processed central portion image 254 to the SDRAM 205.

The object detection unit 204 receives and processes the image-processed peripheral portion image 252 and the image-processed central portion image 254 stored in the SDRAM 205, and outputs the sensor control information and the lens control information to the camera control unit 101. It should be noted that the object detection unit 204, for example, outputs the detection information about the object 5 to an image analysis unit and the like, not shown.

The image analysis unit also receives and performs analysis processing on, for example, the peripheral portion image-capturing image 251, the central portion image-capturing image 253, and the like stored in the SDRAM 205, and, for example, performs various kinds of automatic processing and generation of an alarm in an automobile. It is to be understood that the image-capturing device according to the present embodiment can be applied to various fields.

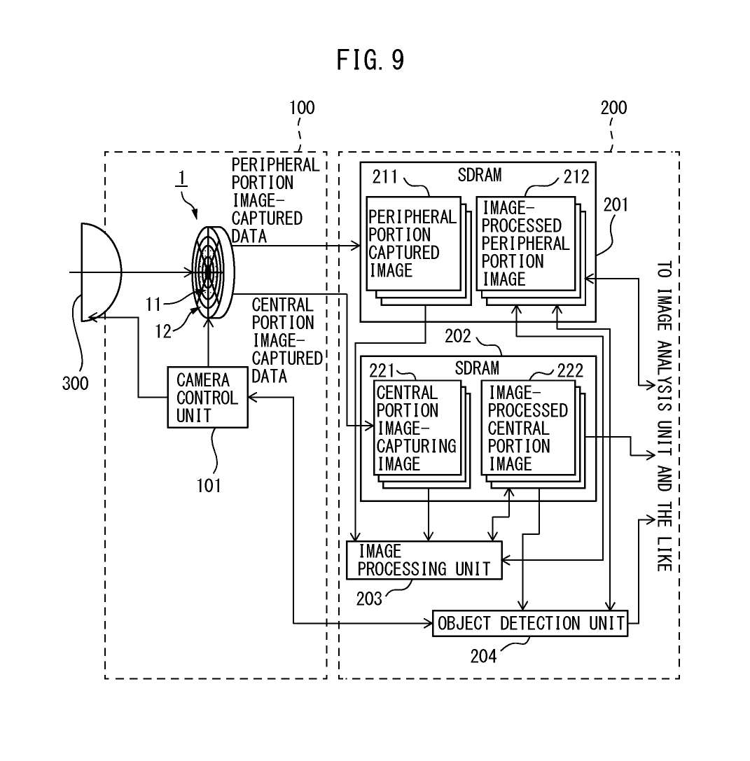

FIG. 9 is a drawing illustrating an image-capturing device according to the second embodiment, and like the first embodiment of FIG. 8, for example, FIG. 9 illustrates an example of an image-capturing device applied to an image processing system such as a monitor camera and a vehicle-mounted camera.

As is evident from the comparison of FIG. 8 explained above and FIG. 9, an SDRAM 205 of an image processing device 200 according to the first embodiment is divided into a first SDRAM (first memory) 201 for the peripheral portion and a second SDRAM (second memory) 202 for the central portion.

More specifically, peripheral portion image-captured data from the peripheral portion 12 of the sensor 1 are stored into the first SDRAM 201 as a peripheral portion image-capturing image 211, and the central portion image-captured data from the central portion 11 are stored into the second SDRAM 202 as a central portion image-capturing image 221.

The image processing unit 203 receives and processes the peripheral portion image-capturing image 211 stored in the first SDRAM 201 and the central portion image-capturing image 221 stored in the second SDRAM 202. Then, the image processing unit 203 stores the processed images into the first SDRAM 201 as an image-processed peripheral portion image 212 and into the second SDRAM 202 as an image-processed central portion image 222. The configuration other than the above is the same as the first embodiment, and explanation thereabout is omitted.

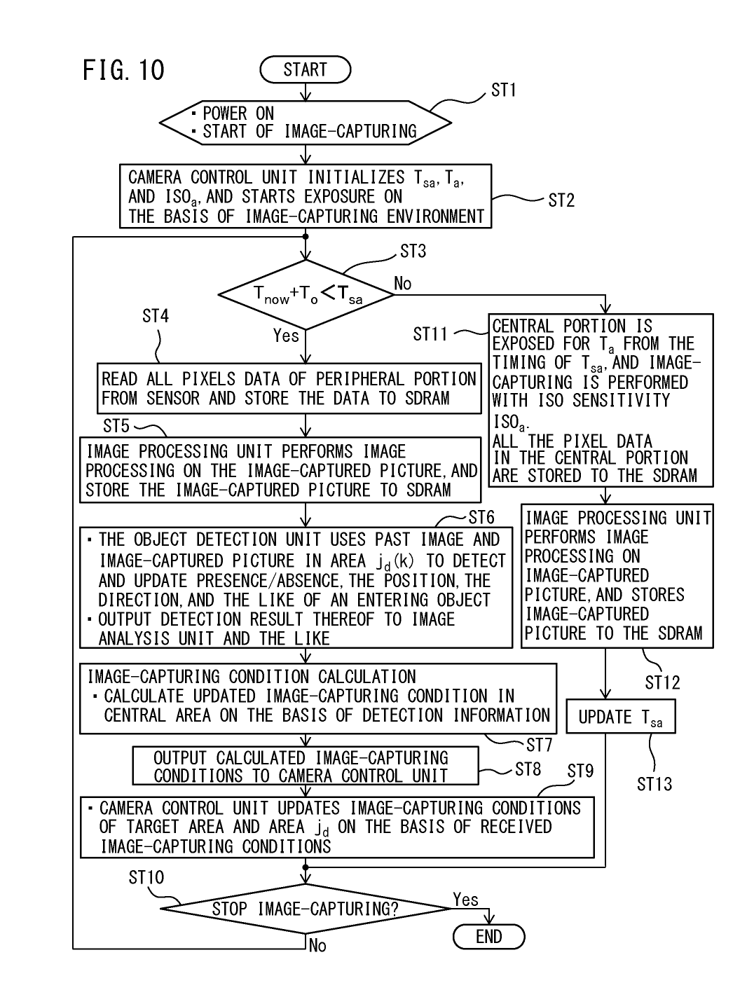

FIG. 10 is a flowchart for explaining an example of image-capturing processing in the image-capturing device according to the present embodiment, and hereinafter, it will be hereinafter explained with reference to the image-capturing device of the first embodiment as shown in FIG. 8. In FIG. 10, a parameter Tnow denotes a current time, To denotes a surrounding area (peripheral portion) exposure time, Tsa denotes a center area (central portion) exposure start timing, and Ta denotes a center area exposure time, and ISOa denotes a center area ISO sensitivity.

As shown in FIG. 10, when the image-capturing processing of the present embodiment is started, the power of the image-capturing device is turned on to start shooting in step ST1. Subsequently, step ST2 is subsequently performed, and the camera control unit 101 initializes Tsa (center area exposure start timing), Ta (center area exposure time), and ISOa (center area ISO sensitivity) and starts the exposure on the basis of the image-capturing environment.

In this case, the peripheral portion 12 of the image sensor 1 thereafter repeats the image-capturing processing while updating, for example, the frame rate, To (surrounding area exposure time), and the ISO sensitivity on the surrounding image-capturing environment. Further, step ST2 is subsequently performed, and Tnow (current time) and To (surrounding area exposure time) are added, and a determination is made as to whether the summation is less than Tsa or not, and more specifically, a determination is made as to whether “Tnow+To<Tsa” is satisfied or not.

In step ST3, when Tnow+To<Tsa is determined to be satisfied (Yes), step ST2 is subsequently performed, and the data of all the pixels (image-captured data) in the peripheral portion 12 are read from the sensor 1 and are stored to the SDRAM 205 (peripheral portion image-capturing image 251). It should be noted that the order of reading of the pixels in each area of the peripheral portion 12 may be in any order.

Subsequently, step ST2 is subsequently performed, and the image processing unit 203 performs image processing on the image-captured picture, which is stored to the SDRAM 205(image-processed peripheral portion image 252) again, and step ST6 is subsequently performed. In step ST6, the object detection unit 204 uses the past image and the image-captured picture in the area ja(k) of the object 5 to detect and update presence/absence, the position, the direction, and the like of an entering object, and outputs the detection result thereof to, for example, an image analysis unit and the like.

Then, step ST2 is subsequently performed, and the image-capturing conditions used in the central portion 11 are calculated, and more specifically, the image-capturing conditions for performing the optimum image-capturing in the central portion (center area) (updated image-capturing condition) is calculated on the basis of the detection information based on the peripheral portion 12.

Depending on the position of the area ja(k) of the object 5 in the sensor 1, the image-capturing conditions for capturing images in the central portion 11 may not be performed. The calculation processing of the image-capturing condition in step ST7 may be performed by the object detection unit 204 of the image processing/image analysis device 200, but may also be performed by the camera control unit 101 of the image-capturing device 100

Subsequently, step ST2 is subsequently performed, and the calculated image-capturing condition is output to the camera control unit 101, and further, step ST9 is subsequently performed. In step ST9, the camera control unit 101 updates the image-capturing conditions of the target area and area jd on the basis of the received image-capturing conditions.

Then, step ST2 is subsequently performed, and a determination is made as to whether to stop the image-capturing, when it is determined to stop the image-capturing, the processing is terminated, and when the it is determined not to stop the image-capturing, step ST3 is performed again, the same processing is repeated until it is determined to stop the image-capturing.

On the other hand, when Tnow+To<Tsa is determined not to be satisfied in step ST3 (No), step ST2 is subsequently performed, and the central portion is exposed for Ta from the timing of Tsa, and the image-capturing is performed with an ISO sensitivity ISOa, and all the pixel data in the central portion are stored to the SDRAM.

Further, step ST2 is subsequently performed, and the same manner as step ST5 explained above, the image processing unit performs the image processing on the image-captured picture, and stores the image-captured picture again to the SDRAM, and step ST13 is subsequently performed. In step ST13, Tsa is updated, and step ST10 is subsequently performed. The processing of step ST10 is as described above.

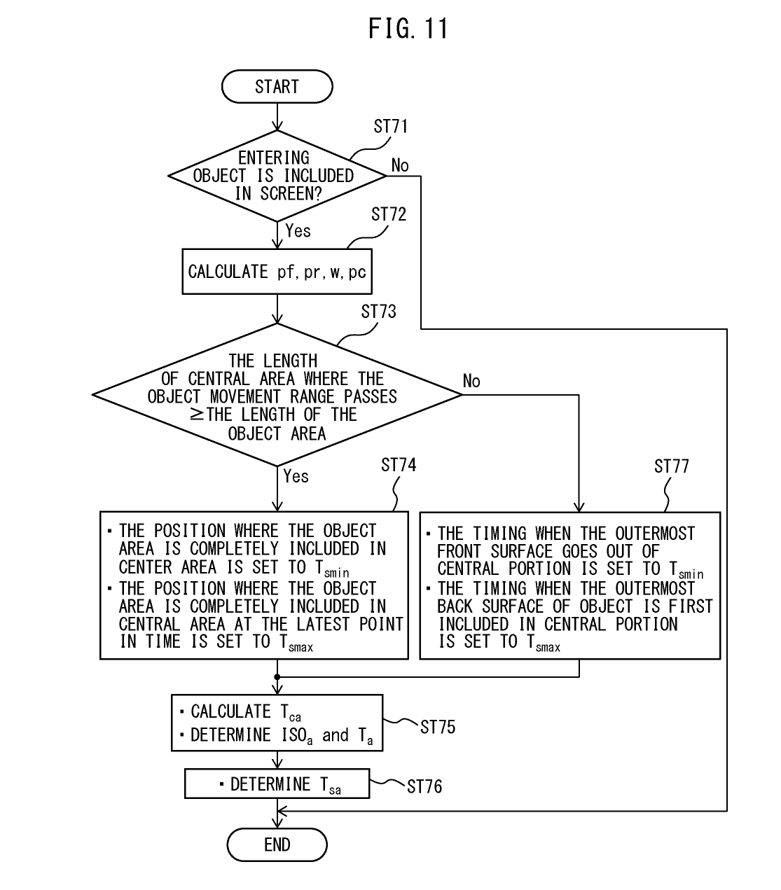

FIG. 11 is a flowchart for explaining an example of calculation processing of image-capturing conditions in the image-capturing device according to the present embodiment, and is to explain an example of image-capturing condition calculation processing of step ST7 in FIG. 10 explained above.

In FIG. 11, the parameter pf denotes the object outermost front surface (corresponding to Of in FIG. 5), pr denotes the object the outermost back surface (corresponding to Or in FIG. 5), w denotes the object width (corresponding to Ow in FIG. 5), and pc denotes the object track (corresponding to Oc in FIG. 5). Further, Tsmin denotes an exposure possible earliest timing, Tsmax denotes an exposure possible the latest timing, and Tca denotes a setting possible exposure time.

In this case, pf (object outermost front surface) corresponds to the surface at the front end of the area of the object 5 that has not yet image-captured. When the rear of the object 5 is the end of the image (when all of the object 5 cannot be seen), pr (object the outermost back surface) corresponds to a surface at a rear end of the image including the surface at the most rearward end in the area of the object 5. It should be noted that pf and pr can be expressed as coordinates on one-dimensional space (of which origin point is any given point) where the travel direction of the object 5 is the axis.

As shown in FIG. 11, when the image-capturing condition calculation processing of the present embodiment (processing of step ST7) is started, a determination is made as to whether an entering object is included in a screen in step ST71, and more specifically, a determination is made as to whether the object 5 has entered into the image sensor 1 (has entered into the field of vision thereof).

In step ST71, when the entering object is determined to be included in the screen (Yes), step ST2 is subsequently performed, and pf, pr, w, and pc are calculated. It should be noted that pf, pr, w, and pc may be calculated in, for example, step ST6 of FIG. 10 together with the position, the speed, the direction, and the like of the object 5.

Further, step ST2 is subsequently performed, a determination is made as to whether the length of the area of the central portion 11 where the movement range of the object 5 passes is equal to or more than the length of the area of the object 5 in the image-captured picture, and more specifically, a determination is made as to whether “the length of the area of the central portion where the object movement range passes the length of the object area” is satisfied or not.

In step ST73, when “the length of the area of the central portion where the object movement range passes the length of the object area” is determined to be satisfied (Yes), step ST74 is subsequently performed, the position where the object area is completely included in the center area for the first time is set to Tsmin (exposure possible earliest timing). Further, the position where the object area is completely included in the area of the central portion at the latest point in time is set to Tsmax (exposure possible the latest timing).

Subsequently, step ST2 is subsequently performed, Tca (setting possible exposure time) is calculated, and ISOa (center area ISO sensitivity) and Ta (center area exposure time) are determined, and step ST2 is subsequently performed, and Tsa (center area exposure start timing) is determined, and the processing is terminated.

On the other hand, in step ST73, when “the length of the center area where the object movement range passes the length of the object area” is determined not to be satisfied (No), step ST77 is subsequently performed, the timing when the outermost front surface of the object 5 goes out of the central portion 11 is set to Tsmin. Further, the timing when the outermost back surface of the object 5 is first included in the central portion 11 is set to Tsmax. Then, steps ST75 and ST76 explained above are performed, and then the processing is terminated.

When the entering object is determined not to be included in the screen (No) in step ST71, it is not necessary to perform the calculation processing of the image-capturing conditions in the central portion 11 of the image sensor 1, and therefore, the processing is terminated as it is.

In the above explanation, the processing explained with reference to FIG. 10 and FIG. 11 is merely an example, and it is to be understood that various methods can be applied as long as it is a control method capable of performing image-capturing for capturing the entire object 5. The image sensor 1 is not limited to an image sensor divided into two areas, i.e., the central portion 11 and the peripheral portion 12, and, for example, the image sensor 1 may be divided into three or more areas such as providing an intermediate portion between the central portion and the peripheral portion.

The present embodiment may not only be applied to those that capture motion pictures, but also be applied to those that capture still pictures, and the captured motion pictures and still pictures may be provided to the user as they are, but may also be given as image data to the image processing system that performs detection and analysis of the object.

Further, the order in which the areas are read from the sensor 1 can be managed by, for example, a queue and the like The image-capturing conditions of the central portion 11 of the sensor 1 can be adjusted on the basis of the movement information of the object 5 in the peripheral portion 12.

In the above explanation, a case where the image-capturing condition for each area is constant has been considered, but, for example, when pixels of different sizes exist in a mixed manner in the same area, the image-capturing conditions may be changed and set for each of different sizes of the pixels. Further, instead of sending the image-capturing conditions for all the pixel sizes, it may also be possible to send information for allowing the control unit side of the sensor 1 to calculate the image-capturing conditions in accordance with the pixel size.

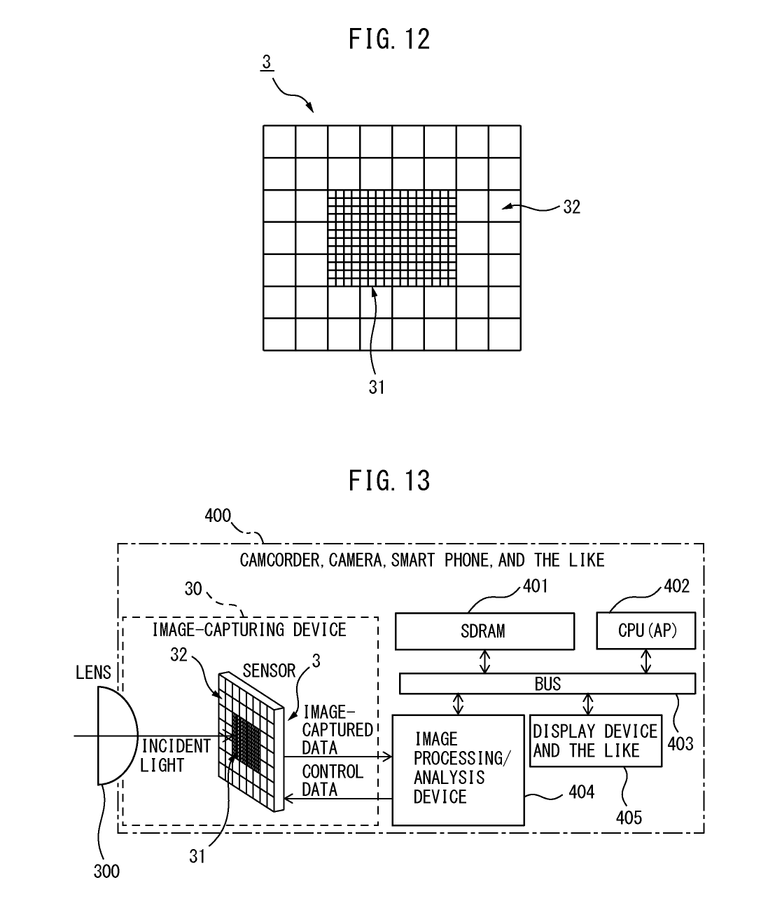

FIG. 12 is a drawing for explaining another example of an image sensor applied to an image-capturing device according to the present embodiment. An image sensor 3 shown in FIG. 12 is substantially the same as the rectangular coordinate system sensor 2 explained with reference to FIG. 4(d) to FIG. 4(f).

More specifically, in the central portion 31 of the sensor 3, the pixel size is small, and the pixel density is high, and the image-capturing is performed with a low frame rate, and in the peripheral portion 32 of the sensor 3, the pixel size is large, and the pixel density is low, and the image-capturing is performed with a high frame rate.

However, what is assumed here is a sensor provided with a new sensor area (peripheral portion) 32 for the periphery of the image sensor (central portion) 31 currently used in, for example, a digital camera, a smartphone, and a camcorder, or a vehicle-mounted camera, and the like.

Further, by using the movement information of the subject (for example, the moving object 5) based on the peripheral portion 32, the image-capturing conditions (image-capturing timing, exposure time, ISO sensitivity, and the like) suitable for capturing the object 5 in the central portion 31 are calculated. Then, the central portion 31 (currently used image sensor) captures the moving object 5 on the basis of the calculated optimum image-capturing conditions.

It should be noted that the peripheral portion 32 may be applied upon making an improvement such as, for example, making the surrounding area of the currently used image sensor into a single pixel by combining multiple pixels (for example, 4, 8, 16 pixels and the like) and enhancing the frame rate of the peripheral portion.

FIG. 13 is a drawing illustrating an image-capturing device according to the third embodiment, and illustrates an example of an image-capturing device applied to, for example, a digital camera, a smart phone, a camcorder, and the like. As shown in FIG. 13, an image-capturing device 400 according to the third embodiment includes an image-capturing device 30, an SDRAM 401, a CPU (Central Processing Unit) 402, a bus 403, an image processing/analysis device 404, a display device 405, and an optical system (lens) 300. It should be noted that the CPU 402 may be an AP (Application Processor).

In this case, the image-capturing device 30, the image processing/analysis device (image processing device) 404, and the optical system 300 correspond to, for example, the image-capturing device 100, the image processing device 200, and the optical system 300, respectively, of FIG. 8 explained above. It should be noted that, in FIG. 13, the camera control unit 101 of FIG. 8 is included in the sensor 8.

First, for example, considered below is a case where, in watching a sports game and the like, an image-capturing device 400 according to the third embodiment as shown in FIG. 13 captures images of the sports. At this occasion, for example, the type of the object (for example, whether it is a ball or a player) at the point in time when the moving object analysis is performed can be determined in the peripheral portion 32 of the sensor 3 on the basis of information about the color, the size, and the like of the moving object (object 5). Then, from the information based on the peripheral portion 32, the image-capturing conditions of the central portion 31 which are the optimum compositions can be calculated before the image capturing in the central portion 31 is performed.

For example, in a general environment other than sports in which what kind of object 5 enters cannot be expected, the motion and the size of the object 5 can be detected in the peripheral portion 32, and therefore, the image-capturing can be done with the timing of the optimum composition although a simplified algorithm is used in the same manner.

In the processing in this case, for example, the image in the peripheral portion is captured by the peripheral portion 32 of the sensor 3, and stored to an SDRAM 401 as a peripheral portion image-capturing image. In the image processing device 404, for example, processing is performed by the image processing unit (203) and the object detection unit (204) provided in the image processing device 404 explained with reference to FIG. 8, and it is sent to the image analysis unit.

Then, the image analysis unit performs, for example, the analysis of the object 5, and the central portion 31 calculates the image-capturing conditions in the optimum composition, and the image-capturing conditions are given to the sensor 3 as control data. It should be noted that the analysis processing of the optimum composition and the like explained above is, for example, executed by the image analysis unit, the CPU (AP) 402, or the like of the image processing device 404.

Subsequently, a case will be considered in which the image-capturing device 400 according to the third embodiment as shown in FIG. 13 performs the image-capturing under a situation where the image-capturing environment changes rapidly. At this occasion, according to the present embodiment, for example, when the type and the brightness of the light source changes, the change can be immediately detected in the peripheral portion 32, and the performance of the automatic exposure (AE) and the automatic white balance (AWB) can be improved.

As the processing in this case, the processing of the AE and the AWB is performed as image processing in general, and therefore, for example, without using the image analysis unit, the peripheral portion 32 of the sensor 3 captures the image of the peripheral portion, and the image is stored to the SDRAM 401 as a peripheral portion image-capturing image. The image processing device 404 performs, for example, processing of the peripheral portion image-capturing image, and performs the AE and the AWB in the central portion 31, and performs the image-capturing with the central portion 31 on the basis of the result of the AE and the AWB.

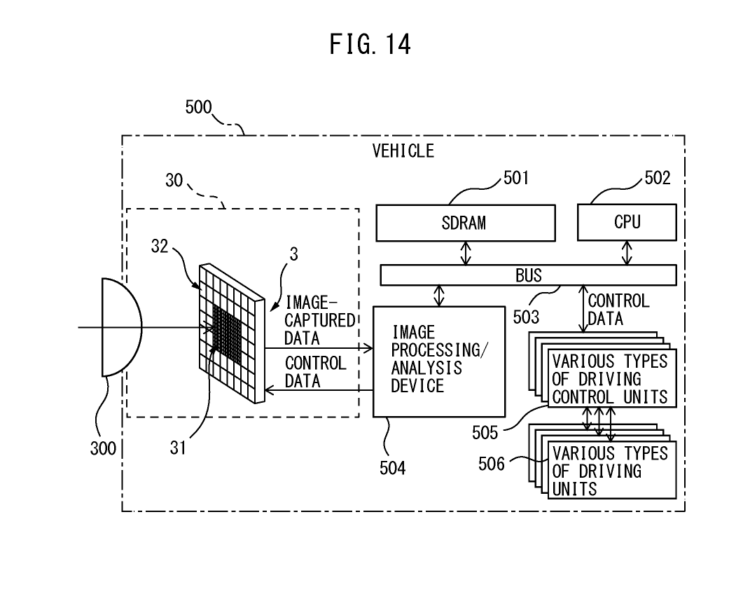

FIG. 14 is a drawing illustrating an image-capturing device according to the fourth embodiment, and illustrates an example of an image-capturing device when au automobile is controlled with a vehicle-mounted camera. As shown in FIG. 14, an image-capturing device 500 according to the fourth embodiment includes an image-capturing device 30, an SDRAM 501, a CPU 502, a bus 503, an image processing/analysis device 504, various types of driving control units 505, various types of driving units 506, and an optical system (lens) 300.

In this case, for example, the image-capturing device 30, the image processing/analysis device (image processing device) 504, and the optical system 300 correspond to the image-capturing device 100, the image processing device 200, and the optical system 300, respectively, of FIG. 8 explained above. In FIG. 14, the camera control unit 101 of FIG. 8 is included in the sensor 3.

The image-capturing device according to the fourth embodiment can be applied to, for example, those that immediately detect an approaching object 5 and control the vehicle in order to avoid or reduce the damage in the accident. In the processing in this case, for example, the peripheral portion 32 of the sensor 3 captures the image in the peripheral portion, and the image is stored to the SDRAM 501 as a peripheral portion image-capturing image.

In the image processing device 504, the image processing unit (203) and the object detection unit (204) perform processing, and the image is sent to the image analysis unit. For example, the image analysis unit analyzes the object 5, and the image-capturing conditions with the optimum composition in the central portion 31 are calculated, and the image-capturing conditions are given to the sensor 3 as control data.

Therefore, for example, the image captured by the central portion 31 of the sensor 3 can be captured with the optimum image-capturing condition suitable for capturing the approaching object 5, and the image captured by the central portion 31 is stored to the SDRAM 501 as a central portion image-capturing image.

Further, in the image processing device 504, the image processing unit (203) and the object detection unit (204) perform processing, and the image is sent to the image analysis unit, and the detailed analysis of the object 5 is performed, and on the basis of the analysis result, control information is sent to various kinds of driving control unit 505.

Then, various kinds of driving control unit 505 control various kinds of driving units 506 to control the vehicle provided with the image-capturing device according to the fourth embodiment. It should be noted that various kinds of driving units 506 include, for example, an actuator for driving a throttle of an engine, a brake, an airbag, or the like. As described above, the image-capturing device and the image-capturing method of the present embodiment can be widely applied to various fields that handle images.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations can be made hereto without departing from the spirit and scope of the invention.

What is claimed is:

1. An image-capturing device comprising:
an image sensor including a central portion configured to perform image-capturing with a first frame rate, and a peripheral portion provided around the central portion configured to perform image-capturing with a second frame rate higher than the first frame rate; and
an image processing device configured to calculate an image-capturing condition in the central portion on the basis of image data captured by the peripheral portion.

2. The image-capturing device as claimed in claim 1, wherein the image processing device is configured to calculate movement information about an object when the image data include the object, and is configured to calculate, from the calculated movement information, the image-capturing condition for a case where image-capturing of the object is performed with the central portion.

3. The image-capturing device as claimed in claim 2, wherein the movement information includes information about a position, a speed, and a movement direction of the object in the image data.

4. The image-capturing device as claimed in claim 3, wherein the movement information further includes information about acceleration of the object in the image data.

5. The image-capturing device as claimed in claim 1, wherein the image-capturing condition includes an image-capturing timing, an exposure time, and an ISO sensitivity of the object in the central portion.

6. The image-capturing device as claimed in claim 1, wherein a size of a pixel in the peripheral portion is larger than a size of a pixel in the central portion, and a pixel density in the peripheral portion is lower than a pixel density in the central portion.

7. The image-capturing device as claimed in claim 1, wherein sizes of pixels in the central portion and the peripheral portion are the same, and processing is performed by making multiple pixels into a single pixel in the peripheral portion.

8. The image-capturing device as claimed in claim 1, wherein the image sensor is a polar coordinate system sensor or a rectangular coordinate system sensor.

9. An image-capturing method for performing image-capturing of an object entering into a field of vision of an image sensor by using the image sensor including a central portion for performing image-capturing with a first frame rate and a peripheral portion provided around the central portion to perform image-capturing with a second frame rate higher than the first frame rate, the image-capturing method comprising:
calculating an image-capturing condition in the central portion on the basis of image data captured by the peripheral portion; and
performing image-capturing of the object in the central portion on the basis of the calculated image-capturing condition.

10. The image-capturing method as claimed in claim 9, wherein the calculating the image-capturing condition comprises:
calculating movement information about an object when the image data include the object; and
calculating, from the calculated movement information, the image-capturing condition for a case where image-capturing of the object is performed with the central portion.

11. The image-capturing method as claimed in claim 10, wherein the movement information includes information about a position, a speed, and a movement direction of the object in the image data.

12. The image-capturing method as claimed in claim 11, wherein the movement information further includes information about acceleration of the object in the image data.

13. The image-capturing method as claimed in claim 9, wherein the image-capturing condition includes an image-capturing timing, an exposure time, and an ISO sensitivity of the object in the central portion.

14. The image-capturing method as claimed in claim 9, wherein a size of a pixel in the peripheral portion is larger than a size of a pixel in the central portion, and a pixel density in the peripheral portion is lower than a pixel density in the central portion.

15. The image-capturing method as claimed in claim 9, wherein sizes of pixels in the central portion and the peripheral portion are the same, and processing is performed by making multiple pixels into a single pixel in the peripheral portion.
